(19) United States
(12) Patent Application Publication
(10) Pub. No.: US 2024/0120583 A1
(43) Pub. Date: Apr. 11, 2024

(54) PACKAGING MATERIAL FOR POWER STORAGE DEVICE, PACKAGING CASE FOR POWER STORAGE DEVICE, AND POWER STORAGE DEVICE

(71) Applicant: Resonac Packaging Corporation, Hikone-shi (JP)

(72) Inventor: Naoya KODA, Tokyo (JP)

(73) Assignee: Resonac Packaging Corporation, Hikone-shi (JP)

(21) Appl. No.: 18/137,361

(22) Filed: Apr. 20, 2023

(30) Foreign Application Priority Data
Apr. 21, 2022 (JP) 2022-070091
Mar. 23, 2023 (JP) 2023-046343

(51) Int. Cl. H01M 50/124; H01M 50/119; H01M 50/121; H01M 50/129; H01M 50/133

(52) U.S. Cl. CPC H01M 50/1243; H01M 50/119; H01M 50/121; H01M 50/129; H01M 50/133

(57) ABSTRACT

A packaging material for a power storage device is formed of a laminated material in which a metal foil layer, a substrate layer provided on an outer surface side of the metal foil layer, and a heat-fusible resin layer provided on an inner surface side of the metal foil layer are laminated. The heat-fusible resin layer is arranged on an inner surface of the packaging material. The heat-fusible resin layer is formed of a polyolefin-based film. A ratio E_{IT}/H_{IT} of an indentation modulus E_{IT} to an indentation hardness H_{IT} of the heat-fusible resin layer measured using a Berkovich indenter is in a range of 21 to 50.

### TECHNICAL FIELD

The present invention relates to a packaging material for a power storage device, such as, e.g., a battery and a capacitor. It also relates to a packaging case for a power storage device, and a power storage device.

### BACKGROUND ART

In a power storage device, such as, e.g., a battery (e.g., a lithium-ion secondary battery, an all-solid-state battery) and a capacitor (e.g., an electric double layer capacitor, a lithium-ion capacitor), used for a portable electronic device (e.g., a smartphone, a tablet computer), an electric vehicle (including a hybrid vehicle), a storage battery for generators, and a storage battery for nighttime power, the storage device body is packaged with a packaging material

The packaging material is provided with a metal foil layer, a substrate layer provided on the outer surface side of the metal foil layer, and a heat-fusible resin layer provided on the inner surface side of the metal foil layer in a laminated manner. It is formed of a laminated material in which the above-described layers are integrally bonded in a laminated manner. The heat-fusible resin layer is arranged on the inner surface of the packaging material, and therefore, the inner surface of the packaging material serves as the surface of the heat-fusible resin layer.

In the case of packaging, for example, a power storage main body as a power storage device main body with the packaging material, in order to form a space for accommodating the battery main body with the packaging material, predetermined molding processing, such as, e.g., press molding processing (e.g., deep drawing processing, stretch molding processing) using a molding die, is performed on a packaging material so that the packaging material is formed in a predetermined shape, such as, e.g., a container shape.

In recent years, in order to improve the volume-energy density of a battery, a packaging material is required to be subjected to sharp molding processing, and therefore, the packaging material is required to have good slipperiness to a molding die.

Therefore, in order to increase the slipperiness of the packaging material, the surface roughness of the packaging material is adjusted to fall within a predetermined range. For example, Japanese Unexamined Patent Application Publication No. 2006-318685 (Patent Document 1) discloses that the center line average roughness Ra of the surface of the thermal bonding resin layer (heat-fusible resin layer) of the packaging material is adjusted to 60 nm to 1,000 nm.

As another method for increasing the slipperiness of the packaging material, Japanese Unexamined Patent Application Publication No. 2003-288865 (Patent Document 2) discloses that a sealant film made of a predetermined material in a packaging material contains 1,000 ppm to 5,000 ppm of a lubricant.

Patent Document
Patent Document 1: Japanese Unexamined Patent Application Publication No. 2006-318685
Patent Document 2: Japanese Unexamined Patent Application Publication No. 2003-288865

### SUMMARY OF THE INVENTION

### Problems to be Solved by the Invention

Thus, a battery packaging material is generally productized in the form of a packaging material manufactured by winding an elongated packaging material into a coil shape. In recent years, it is required to lengthen the packaging material to extend the continuous molding processing time.

However, in a case where a packaging material is lengthened, in the packaging material of the center (more specifically, in the vicinity of the winding core member in the packaging material coil) of the packaging material coil obtained by winding the packaging material, a huge compressive load is applied compared with the packing material of the coil periphery. Therefore, the surface shape, such as, e.g., the surface state, of the packaging material of the coil center portion significantly changes with respect to the surface shape of the packaging material of the coil outer peripheral portion, which reduces the surface roughness.

Then, even when the packaging material is unwound from the coil, the surface shape of the packaging material of the coil center portion does not restore to the original shape, that is, the surface roughness remains small.

Therefore, even in a case where the packaging material of the coil outer peripheral portion has good slipperiness, and good molding workability is obtained, slipperiness deteriorates at the packaging material of the coil center portion, and good molding workability cannot be obtained in some cases. Particularly, if the slipperiness of the inner surface (i.e., the surface of the heat-fusible resin layer) of the packaging material contacting the molding die deteriorates, it becomes difficult to obtain a sharp and deep molded shape.

As described above, in a packaging material wound in a coil shape, there is a variation in the molding workability due to the difference in the slipperiness between the coil center portion and the coil outer peripheral portion, and in a case where the packaging material is lengthened, the variation in the molding workability increases.

The present invention has been made in view of the above-described technical background. An object of the present invention is to provide a packaging material for a power storage device with less variation in the molding workability, a packaging case for a power storage device using the packaging material, and a power storage device packaged with the packaging material.

### Means for Solving the Problems

The present invention provides the following measures.

1) A packaging material for a power storage device, comprising:
a laminated material in which a metal foil layer, a substrate layer provided on an outer surface side of the metal foil layer, and a heat-fusible resin layer provided on an inner surface side of the metal foil layer are laminated,
wherein the heat-fusible resin layer is arranged on an inner surface of the packaging material,
wherein the heat-fusible resin layer is formed of a polyolefin-based film, and
wherein a ratio E_{IT}/H_{IT} of an indentation modulus E_{IT} to an indentation hardness H_{IT} of the heat-fusible resin layer measured using a Berkovich indenter is within a range of 21 to 50.

2) The packaging material for a power storage device as recited in the above-described Item 1,
wherein an arithmetic mean height Sa of the inner surface of the packaging material is within a range of 0.07 μm and 0.3 μm.

3) The packaging material for a power storage device as recited in the above-described Item 1 or 2, wherein the polyolefin-based film is formed of at least one-layer film, wherein at least in the one-layer film, a film forming the inner surface of the packaging material contains 500 ppm to 3,000 ppm by mass content of a fatty acid amide-based lubricant.

4) A packaging case for a power storage device provided with a deep-drawn molded article or a stretch-molded article of the packaging material as recited in any one of the above-described Items 1 to 3.

5) A power storage device in which a power storage device main body is accommodated in a packaging case provided with a deep-drawn molded article or a stretch-molded article of the packaging material as recited in any one of the above-described Items 1 to 3.

### Effects of the Invention

The present invention has the following advantages.

In the above-described Item 1, the ratio E_{IT}/H_{IT} of the indentation modulus E_{IT} to the indentation hardness H_{IT} of the heat-fusible resin layer measured using a Berkovich indenter is within the range of 21 to 50. Therefore, even in a case where the packaging material is wound into a coil shape, when the packaging material is unloaded from the coil, the surface shape of the inner surface of the packaging material of the coil center portion restores to the original shape. Therefore, in the packaging material, there is less variation in the molding workability over the length region from the coil outer peripheral portion to the coil center portion, i.e., over the substantially entire length region of the packaging material. For this reason, it is possible to obtain stable molding processability over the substantially entire length region of the packaging material.

In the above-described Item 2, the arithmetic average height Sa of the inner surface of the packaging material is within the range of 0.07 μm to 0.3 μm. Therefore, the inner surface of the packaging material has good slipperiness in a state before winding the packaging material into a coil shape. Even in the unloaded state in which the packaging material is wound into a coil shape and then the packaging material is unwound from the coil, the surface shape of the inner surface of the packaging material assuredly restores to a range that exhibits good slipperiness. Therefore, it is possible to assuredly obtain good molding workability over the substantially entire length region of the packaging material.

Further, when Sa is 0.3 μm or less, in a case where the packaging material is molded, the color tone difference between the portion of the packaging material subjected to severe molding processing and the portion not subjected to molding processing is assuredly reduced. Therefore, a molded article with a good appearance can be assuredly obtained, and contamination of an electrolyte at the heat-sealed portion of the packaging material can be assuredly suppressed in the production process of the power storage device.

In the above-described Item 3, it is possible to assuredly obtain good slipperiness on the inner surface of the packaging material.

In the above-described Item 4, a packaging case having a sharp and deep molded shape can be provided.

In the above-described Item 5, a power storage device covered with a packaging case having a sharp and deep molded shape can be provided.

### BRIEF DESCRIPTION OF THE DRAWINGS

FIG. 1 is a schematic cross-sectional view of a packaging material for a power storage device according to a first embodiment of the present invention.

FIG. 2 is a schematic cross-sectional view of a packaging material for a power storage device according to a second embodiment of the present invention.

FIG. 3 is a schematic cross-sectional view of a packaging material for a power storage device according to a third embodiment of the present invention.

FIG. 4 is a schematic side view of a packaging material coil.

FIG. 5 is a schematic cross-sectional view of a power storage device according to one embodiment of the present invention.

FIG. 6 is a schematic perspective view showing the power storage device in an exploded state.

### EMBODIMENTS FOR CARRYING OUT THE INVENTION

Some embodiments of the present invention are described below with reference to the attached drawings.

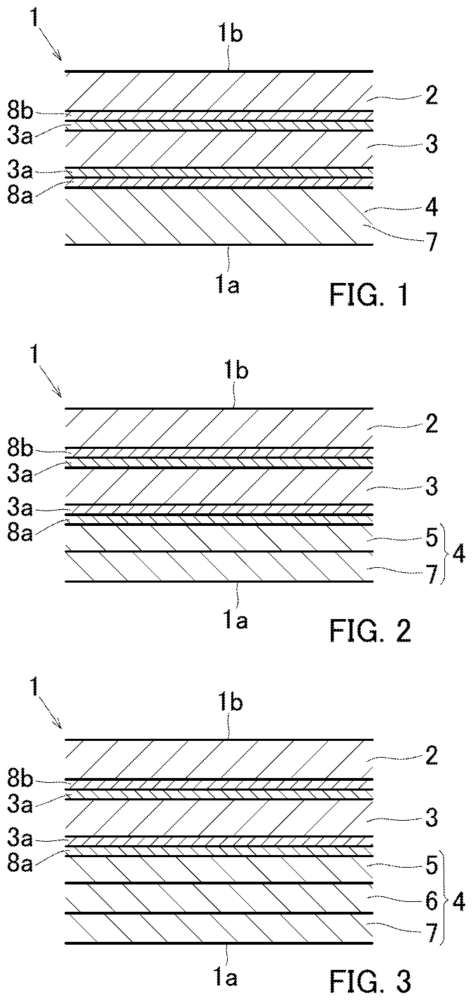

As shown in FIG. 1, a packaging material 1 for a power storage device according to the first embodiment of the present invention is basically formed of a laminated material in which a metal foil layer 3, a substrate layer 2 arranged on the outer surface side of the metal foil layer 3, and a heat-fusible resin layer 4 arranged on the inner surface side of the metal foil layer 3 are laminated. These layers 2 to 4 are integrally bonded in a laminated state. Note that the reference symbol “1a” denotes the inner surface of the packaging material 1, and the reference symbol “1b” denotes the outer surface of the packaging material 1.

Specifically, the substrate layer 2 and the metal foil layer 3 are bonded to each other via an outer side adhesive layer 8b arranged between the layers 2 and 3. The metal foil layer 3 and the heat-fusible resin layer 4 are bonded to each other via an inner side adhesive layer 8a arranged between the layers 3 and 4.

In the packaging material 1, the heat-fusible resin layer 4 is arranged on the inner surface 1a of the packaging material 1. Therefore, the inner surface 1a of the packaging material 1 serves the surface of the heat-fusible resin layer 4.

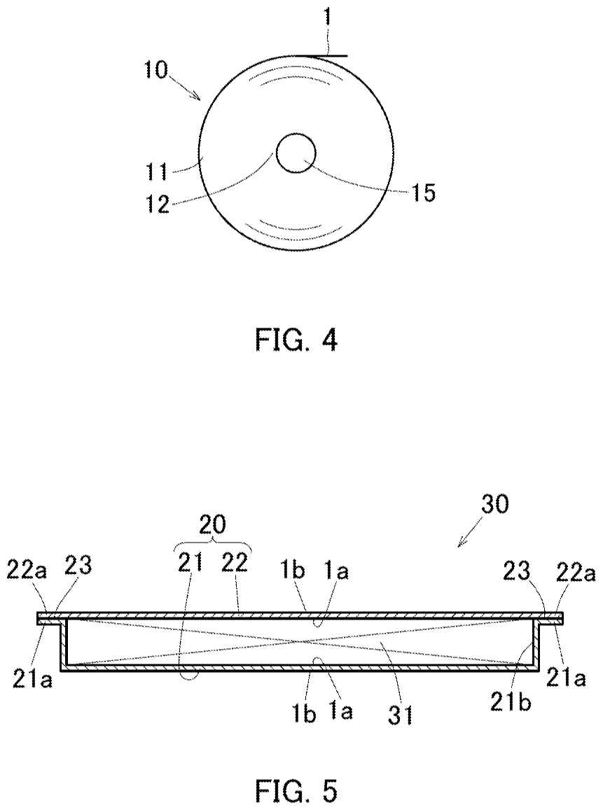

As shown in FIG. 4, the packaging material 1 is generally produced in the form of a packaging material coil 10 which is a long strip and is produced by winding it around a core member 15 in a coil shape. Typically, the length of the elongated packaging material 1 is within the range of 2,000 m to 4,000 m, the inner diameter of the coil 10 (i.e., the diameter of the core member 15) is within the range of 100 mm to 300 mm, and the outer diameter of the coil 10 is within the range of 600 mm to 900 mm. When subjecting the packaging material 1 to molding processing, the packaging material 1 is unwound from the coil 10 and subjected to molding processing.

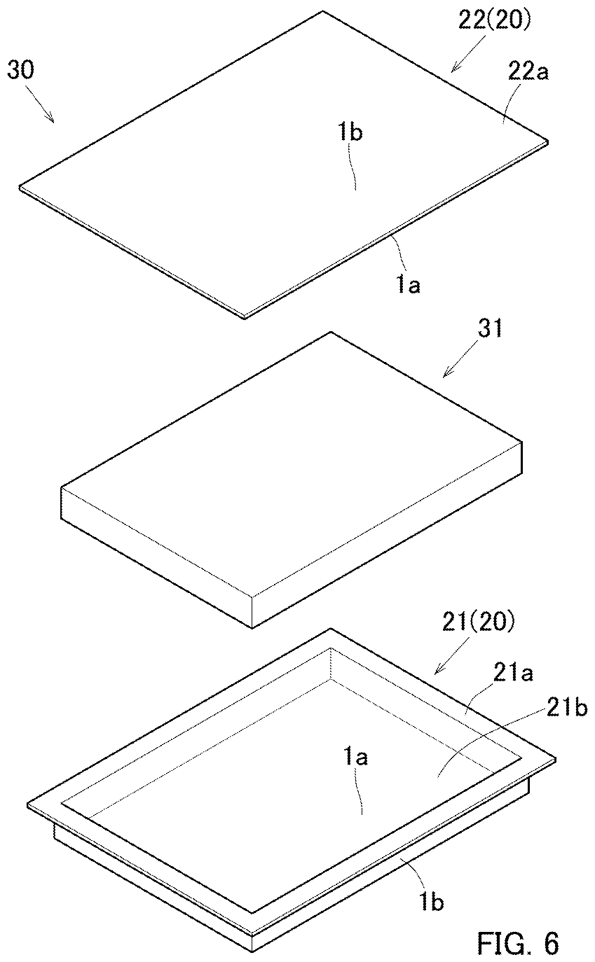

In this first embodiment, the packaging material 1 is used to package a power storage device, such as, e.g., a lithium-ion secondary battery 30, as shown in FIGS. 5 and 6.

The lithium-ion secondary battery 30 is provided with a battery main body 31 as a power storage device main body and a packaging case 20 for accommodating the battery main body 31. As shown in FIG. 6, the packaging case 20 is provided with a packaging case body 21 in the form of a rectangular parallelepiped container with an opening opened upward, and a plate-shaped lid 22 for closing the opening of the packaging case body 21.

The packaging case body 21 is produced by subjecting the above-described packaging material 1 to deep drawing or stretch forming using a molding die into a rectangular parallelepiped container shape so that the inner surface 1a of the packaging material 1 faces inward. That is, the packaging case body 21 is a deep-drawn molded article or a stretch-molded article of the packaging material 1.

A recess 21b for accommodating the battery main body 31 is provided at the center of the inner surface 1a of the packaging case body 21, and an outwardly protruding flange portion 21a is provided as a part to be joined at the outer peripheral portion of the packaging case body 21.

The lid 22 is used in a flat state without subjecting the packaging material 1 to molding processing, and the outer peripheral portion 22a of the lid 22 is a portion to be bonded.

In the battery 30, the battery main body 31 is accommodated in the recess 21b of the packaging case body 21. The lid 22 is arranged on the packaging case body 21 with its inner surface 1a facing toward the battery main body 31 (lower side). The heat-fusible resin layer (4, see FIG. 1) of the flange portion (portion to be bonded) 21a of the packaging case body 21 and the heat-fusible resin layer (4, see FIG. 1) of the outer peripheral portion (portion to be bonded) 22a of the lid 22 are heat-sealed (bonded) in a hermetically sealed state. With this, a battery 30 in a state in which the battery main body 31 is surrounded by the packaging case 20 is formed.

Note that the reference symbol “23” in FIG. 5 denotes a heat-sealed portion (thermally fused portion) between the heat-fusible resin layer 4 of the flange portion 21a of the packaging case body 21 and the heat-fusible resin layer 4 of the outer peripheral portion 22a of the lid 22.

In the battery 30, the inner surface 1a of the packaging material 1 forming the packaging case body 21 faces the battery main body 31, and the inner surface 1a of the packaging material 1 forming the lid 22 faces the battery main body 31.

A tab lead connected to the battery main body 31 is generally led out from the battery main body 31 through the heat-sealed portion 23 to the outer surface side of the packaging case 20. Note that the tab lead is not illustrated in FIG. 5 and FIG. 6.

Next, the configuration of the packaging material 1 will be described in detail.

In the packaging material 1 of this first embodiment shown in FIG. 1, the substrate layer 2 is made of a heat-resistant resin, specifically formed of a heat-resistant resin film. As the heat-resistant resin film, a biaxially stretched polyamide film, a biaxially stretched polybutylene terephthalate (PBT) film, a biaxially stretched polyethylene terephthalate (PET) film, or a biaxially stretched polyethylene naphthalate (PEN) film is preferably used. The polyamide film is not particularly limited, and for example, a 6 nylon film, a 6,6 nylon film, an MXD nylon film, or the like can be suitably used among them.

The substrate layer 2 may be formed of a single layer or may be formed of a multiple layer. In a case where the substrate layer 2 is formed of a multiple layer, the substrate layer 2 may have a multilayer structure composed of a PET film and a polyamide film.

Further, as the heat-resistant resin of the substrate layer 2, it is preferable to use a resin having a melting point higher by 10° C. or more, more preferably 20° C. or more, with respect to all resins constituting the heat-fusible resin layer 4.

The thickness of the substrate layer 2 is not limited and may preferably be within the range of 9 μm to 50 μm.

The metal foil layer 3 is formed of a metal foil. As the metal foil, an aluminum (Al) foil, a copper (Cu) foil, a stainless steel (SUS) foil, a titanium (Ti) foil, a nickel (Ni) foil, or the like may be used alone, or a clad material obtained by laminating two or more kinds of metal foils may be used. Among them, an aluminum foil is preferably used as the metal foil. Particularly, an Al—Fe-based alloy foil containing Fe of 0.7 mass % to 1.7 mass % among aluminum foils has excellent strength and ductility, so that good molding workability can be assuredly obtained.

The thickness of the metal foil layer 3 is not limited and may preferably be within the range of 20 μm to 100 μm. An underlying layer 3a is preferably formed on at least one of the inner surface and the outer surface of the metal foil layer 3. In this first embodiment, the underlying layer 3a is formed on both the inner and outer surfaces of the metal foil layer 3.

The underlying layer 3a can be formed by applying a silane coupling agent or performing a chemical conversion treatment, such as, e.g., a chromate treatment. By forming the underlying layer 3a, it is possible to improve the adhesive strength with the adhesive layers 8a and 8b provided on both the inner and outer surfaces of the metal foil layer 3, which can effectively suppress the peeling of the adhesive layer 8a, 8b.

In the case of forming the underlying layer 3a by a coating (chemical conversion treatment coating) by a chemical conversion treatment, the chemical conversion treatment coating may sometimes be selected by the combination with the adhesive layer 8a, 8b, but as the chemical conversion treatment coating, a coating by a chromic acid treatment, a coating by a phosphoric acid chromate treatment, a coating by a phosphoric acid zinc-treatment, a coating by a non-chromic acid salt-treatment using zirconium or titanium as a Cr substitute metallic component, an oxide coating by a boehmite treatment, and the like can be suitably used.

The thickness of the underlying layer 3a is not limited and may preferably be within the range of 0.01 μm to 1 μm.

As the adhesive constituting the outer side adhesive layer 8b, for example, it is possible to use a two-part curing type adhesive composed of a first liquid made of one or two or more polyols selected from the group consisting of a polyurethane-based polyol, a polyester polyol, a polyether-based polyol, and a polyester urethane-based polyol and a second liquid (curing agent) composed of isocyanate.

The thickness of the outer side adhesive layer 8b is not limited and may preferably be within the range of 2 μm to 5 μm.

As the adhesive constituting the inner side adhesive layer 8a, an adhesive containing at least one type of a resin selected from the group consisting of a polyurethane-based resin, an acryl-based resin, an epoxy-based resin, a polyolefin-based resin, an elastomer-based resins, a fluorine-based resin, and an acid-modified polypropylene resins can be preferably used. Particularly, it is preferable to use an adhesive in which an acid-modified polyolefin, such as, e.g., an acid-modified polypropylene resin, is a main agent.

The thickness of the inner side adhesive layer 8a is not limited and may preferably be within the range of 2 μm to 5 μm.

The heat-fusible resin layer 4 is formed of a polyolefin-based film. As the polyolefin-based film, a polyethylene-based film, a polypropylene (e.g., rPP, bPP, hPP)-based film, or the like is used, and a non-stretched film, such as, e.g., a cast polypropylene (CPP) film and an inflation polypropylene (IPP) film, is preferably used. Further, as the non-stretched film, a homopolymer or an ethylene-propylene copolymer is preferably used. Further, the outer surface (that is, the surface to be bonded to the metal foil layer 3 in the polyolefin-based film) of the polyolefin-based film is preferably subjected to a corona treatment.

The thickness of the heat-fusible resin layer (polyolefin-based film) 4 is not limited and is preferably within the range of 20 μm to 120 μm, particularly preferably within the range of 30 μm to 80 μm.

The heat-fusible resin layer 4 includes a seal layer 7 serving the inner surface 1a of the packaging material 1. In this first embodiment, the heat-fusible resin layer 4 is constituted only by the seal layer 7. However, in the present invention, the heat-fusible resin layer 4 is not limited to being constituted only by the seal layer 7 and may be constituted by multiple layers including the seal layer 7 of, for example, the second and third embodiments shown in FIG. 2 and FIG. 3.

That is, in the second embodiment (FIG. 2), the heat-fusible resin layer 4 is composed of two layers of a seal layer 7 and a laminate layer 5 arranged on the metal foil layer 3 side. In the third embodiment (FIG. 3), the heat-fusible resin layer 4 is constituted by three layers, i.e., the seal layer 7, the laminate layer 5, and an intermediate layer 6 arranged between both the layers 5 and 7. Therefore, even in a case where the heat-fusible resin layer 4 is constituted by only the seal layer (single layer) 7 or multiple layers, the seal layer 7 is arranged as the innermost layer of the heat-fusible resin layer 4 of the packaging material 1 and serves the inner surface 1a of the packaging material 1.

Hereinafter, the above-described polyolefin-based film constituting the heat-fusible resin layer 4 is also referred to as “heat-fusible resin film.”

In a case where the heat-fusible resin layer 4 is constituted by a single layer as in the first embodiment, the heat-fusible resin film is formed of a single layer film. In a case where the heat-fusible resin layer 4 is constituted by two layers as in the second embodiment, the heat-fusible resin film 4 is formed of a two-layer film. In a case where the heat-fusible resin layer 4 is constituted by three layers as in the third embodiment, the heat-fusible resin film 4 is formed of a three-layer film. Such a multilayer film can be formed by coextrusion.

In a case where the heat-fusible resin film 4 is formed of a single-layer film, the entire heat-fusible resin layer 4 serves the seal layer 7. In a case where the heat-fusible resin film 4 is formed of a two-layer film, the film of the two-layer film arranged on the inner surface 1a side of the packaging material 1 serves the seal layer 7 of the heat-fusible resin layer 4, and the film arranged on the metal foil layer 3 side serves the laminate layer 5 of the heat-fusible resin layer 4. In a case where the heat-fusible resin film 4 is formed of a three-layer film, the film of the three-layer film arranged on the inner surface 1a side of the packaging material 1 serves the seal layer 7 of the heat-fusible resin layer 4, the film arranged on the metal foil layer 3 side serves the laminate layer 5 of the heat-fusible resin layer 4, and the film arranged between the two films serves the intermediate layer 6 of the heat-fusible resin layer 4.

Further, in a case where the heat-fusible resin film 4 is formed of a three-layer film, the thickness ratio of the laminate layer 5, the intermediate layer 6, and the seal layer 7 is not limited and is preferably 1 to 1.5: 7 to 8:1 to 1.5.

The melting point of the heat-fusible resin film is not limited and may preferably be within the range of 100° C. to 200° C.

Further, in order to enhance the heat-sealing property, the delamination resistance, the electrical insulation property, and the like of the heat-fusible resin layer 4, the seal layer 7 and the laminate layer 5 are preferably made of an ethylene-propylene random copolymer (rPP), and the intermediate layer 6 is preferably made of an ethylene-propylene block copolymer (bPP) or an polypropylene homopolymer (hPP).

In the heat-fusible resin layer 4, at least the seal layer 7 preferably contains at least one of an anti-blocking material (AB material) and a roughening material.

The AB material is composed of fine particles having an average particle diameter of 0.05 μm or more and 5 μm or less. Specifically, as the AB material, fine particles of, e.g., silica, alumina, calcium carbonate, barium carbonate, titanium oxide, aluminum silicate, talcum, kaoline, acrylic resin beads, and polyethylene resin beads are used.

In a case where the heat-fusible resin film is formed of a multilayer film, the AB material is preferably contained especially in the seal layer 7.

The mass content of the AB material in a layer (e.g., the seal layer 7) containing the AB material is not limited and is preferably within the range of 500 ppm to 3,500 ppm.

The roughening material is composed of particles having an average particle diameter in the range of more than 5 μm to 20 μm or less. Specifically, as the roughening material, particles of, e.g., silica, alumina, calcium carbonate, barium carbonate, titanium oxide, aluminum silicate, talcum, kaoline, acrylic resin beads, and polyethylene resin beads are used.

In a case where the heat-fusible resin film 4 is formed of a multilayer film, the roughening material is preferably contained in the seal layer 7.

The mass content of the roughening material in the layer (e.g., the seal layer 7) containing the roughening material is not limited and may preferably be within the range of 500 ppm to 3,500 ppm.

Furthermore, the thickness of the layer (e.g., the seal layer 7) containing the roughening material is preferably within the range of 5 μm to 20 μm. When the thickness of this layer is 5 μm or more, it is possible to assuredly suppress the roughening material from falling off from this layer. When the thickness of the layers is 20 μm or less, it is possible to assuredly suppress the decrease in the stiffness of the heat-fusible resin layer 4 due to the inclusion of the roughening material.

In the heat-fusible resin layer 4, a lubricant is preferably added to at least the seal layer 7. By adding a lubricant, it is possible to assuredly adjust the slipperiness of the inner surface 1a of the packaging material 1 to a suitable range. As a result, the packaging material 1 can be assuredly subjected to sharp and deep molding processing 1.

As the lubricant, it is possible to use: a saturated fatty acid amide (e.g., a lauramide, a palmitamide, a stearamide, a behenamide, a hydroxystearamide); an unsaturated fatty acid amide (e.g., an oleamide, an erucamide); a substituted amide (e.g., an N-oleyl palmitamide, an N-stearyl stearamide, an N-stearyl oleamide, an N-oleyl stearamide, an N-stearyl erucamide); a methylolamide (e.g., a methylol stearamide); a saturated fatty acid bisamide (e.g., a methylenebisstearamide, an ethylenebiscaprinamide, an ethylenebislauramide, an ethylenebisstearamide, an ethylenebishydroxystearamide, an ethylenebisbehenamide, a hexamethylenebisstearamide, a hexamethylenebisbehenamide, a hexamethylenehydroxystearamide, an N,N′-distearyladipamide, an N,N′-distearylsebacinamide); an unsaturated fatty acid bisamide (e.g., an ethylenebisoleamide, an ethylenebiserucamide, a hexamethylenebisoleamide, an N,N′-dioleyladipamide, an N,N′-dioleylsebacinamide); a fatty acid ester amide (e.g., a stearamide ethyl stearate); and an aromatic bisamide (e.g., a m-xylylenebisstearamide, a m-xylylenebishydroxystearamide, an N,N′-stearylisophthalic acid amide).

As these lubricants, particularly, a fatty acid amide-based lubricant (i.e., a saturated fatty acid amide, an unsaturated fatty acid amide, a substituted amide, a methylolamide, a saturated fatty acid bisamide, an unsaturated fatty acid bisamide, a fatty acid ester amide, and the like) is preferably used. The reason for this is that the fatty acid amide-based lubricant can be easily mixed and added to the polyolefin-based film material uniformly, and can be easy to bleed out to the surface of the film after aging of the film.

The mass addition rate (hereinafter also referred to as “lubricant addition rate”) of the fatty acid amide-based lubricant in the seal layer 7 is preferably within the range of 500 ppm to 3,000 ppm. The reasons are as follows

When the lubricant addition rate is 500 ppm or more, the inner surface 1a of the packaging material 1 can assuredly obtain good slipperiness. When the lubricant addition rate is equal to or less than 3,000 ppm, it is possible to assuredly reduce the excessive bleed-out amount of the lubricant on the inner surface 1a of the packaging material 1. Therefore, it is possible to assuredly suppress the contamination of the molding die or the production line by the powdery lubricant (hereinafter, also referred to as “lubricant powder”) precipitated on the inner surface 1a of the packaging material 1.

The particularly preferable lower limit of the lubricant addition rate is 600 ppm, and the particularly preferable upper limit is 2,500 ppm.

In a case where the heat-fusible resin film is formed of a multilayer film, the lubricant addition rate in the laminate layer 5 is preferably set to 0 to 1/2 times the lubricant addition rate in the seal layer 7. In a case where the multilayer film includes the intermediate layer 6, the lubricant addition rate in the intermediate layer 6 is preferably set to about twice the lubricant addition rate in the seal layer 7.

Specifically, the lubricant addition rate is preferably set to the following ranges.
Lubricant addition rate in the laminate layer 5: 0 ppm to 2,000 ppm,
Lubricant addition rate in the intermediate layer 6: 1,000 ppm to 6,000 ppm,
Lubricant added in the seal layer 7: 500 ppm to 3,000 ppm.

When the lubricant addition rate in the laminate layer 5 is equal to or less than 2,000 ppm, it is possible to suppress the bleed-out of the lubricant to the surface (outer surface) of the inner side adhesive layer Ba side of the laminate layer 5, and thus it is possible to assuredly adhere the heat-fusible resin layer 4 and the metal foil layer 3. When the lubricant addition rate in the intermediate layer 6 is within the range of 1,000 ppm to 6,000 ppm, it is possible to facilitate the transfer of the lubricant from the intermediate layer 6 to the seal layer 7 to facilitate the bleed-out of the lubricant to the surface (i.e., the inner surface 1a of the packaging material 1) of the seal layer 7. The reason why the lubricant addition rate in the seal layer 7 is preferably set within the range of 500 ppm to 3,000 ppm is as described above.

The quantity of the lubricant powder deposited on the inner surface (i.e., the surface of the heat-fusible resin layer 4) 1a of the packaging material 1 is not limited and may preferably be within the range of 0.1 μg/cm² to 1 μg/cm². When the quantity of the lubricant powder is 0.1 μg/cm² or more, the slipperiness of the inner surface 1a of the packaging material 1 can be assuredly adjusted. When the quantity of the lubricant powder is 1 μg/cm² or less, it is possible to assuredly suppress the contamination of the molding die or the production line by the lubricant powder.

The ratio E_{IT}/H_{IT} of the indentation modulus E_{IT} to the indentation hardness H_{IT} of the heat-fusible resin layer 4 in the packaging material 1 is set to 21 to 50. The reason is as follows. Note that the ratio E_{IT} and H_{IT} are values measured using a Berkovich indenter as an indenter.

When the ratio E_{IT}/H_{IT} is 21 or more, the heat-fusible resin layer 4 is highly shape-recoverable. Therefore, even with the lapse of time in a state in which a large compressive load is applied to the packaging material 1 of the coil center portion 12, in the unloaded state in which the packaging material 1 is unwound from the coil 10, the surface shape, such as, e.g., the surface state of the inner surface 1a of the packaging material 1, restores to the shape close to the surface shape before the packaging material 1 is wound in a coil shape. As a result, the packaging material 1 has a small variation in the molding workability over the length region from the coil outer peripheral portion 11 to the coil center portion 12, that is, over the substantially entire length region of the packaging material 1. Therefore, stable molding workability can be obtained over the substantially entire length region of the packaging material 1.

When the ratio E_{IT}/H_{IT} is less than 21, the shape recoverability of the heat-fusible resin layer 4 is low, and therefore, even when the packaging material 1 is made to the unloaded state in which the packaging material 1 is unwound from the coil 10, the surface shape of the inner surface 1a of the packaging material 1 of the coil center portion 12 is not restored, and therefore, the slipperiness of the inner surface 1a of the packaging material 1 deteriorates.

If the ratio E_{IT}/H_{IT} exceeds 50, the shape-recoverability of the heat-fusible resin layer 4 is excessive, and the followability of the heat-fusible resin layer 4 to the metal foil layer 3 deteriorates. Therefore, delamination is likely to occur between the heat-fusible resin layer 4 and the metal foil layer 3 at a portion (for example, a corner portion of the molded article) where strict molding processing is applied at the time of the molding processing of the packaging material 1. When delamination occurs, the packaging material 1 cannot be molded to a predetermined configuration satisfactorily due to the occurrence of pinholes, cracks, or the like in the packaging material 1 during the molding processing.

Therefore, the ratio E_{IT}/H_{IT} needs to be set within the range of 21 to 50. With this, even when the packaging material 1 is wound in a coil shape, stable molding workability can be obtained over the substantially entire length region of the packaging material 1. The particularly preferred upper limit of the ratio E_{IT}/H_{IT} is 46.

The ratio E_{IT} and H_{IT} of the heat-fusible resin layer 4 varies depending on the conditions (e.g., the type, the melting point, the melt flow rate (MFR), the molecular weight, the additive) of the resin in the heat-fusible resin film 4, and the film formation conditions (e.g., the film thickness, the extent of stretching, the extrusion temperature, the processing rate, the cooling roll temperature, the air knife air volume, the annealing temperature, and the time) of the film. Therefore, by appropriately considering these conditions, the ratio E_{IT}/H_{IT} can be set to 21 to 50. Specifically, it is preferable to adjust the film formation condition of the heat-fusible resin film at the time of producing the heat-fusible resin film as follows.

That is, a heat-fusible resin film obtained by lowering the cooling-roll temperature by 5° C. to 20° C. than the normal cooling-roll temperature and increasing the air-knife air volume than the normal air-knife air volume is annealed at an annealing temperature of 40° C. to 60° C. for an annealing time of 1 to 4 days to relax the stresses of the heat-fusible resin film 4 and accelerate the crystallization. In this way, the ratio E_{IT}/H_{IT} of the heat-fusible resin layer 4 can be set to 21 to 50.

The arithmetic mean height Sa of the inner surface 1a of the packaging material 1 is preferably set within the range of 0.07 μm to 0.3 μm. The reasons are as follows.

When Sa is 0.07 μm or more, the surface roughness of the inner surface (that is, the surface of the heat-fusible resin layer 4) 1a of the packaging material 1 increases, thereby improving slipperiness. Therefore, the molding workability of the packaging material 1 is improved.

When Sa is 0.3 μm or less, in the case of molding the packaging material 1, the color tone difference between the portion subjected to severe molding processing in the packaging material 1 and the portion not subjected to molding processing is assuredly reduced, and therefore, a molded article with a good appearance can be assuredly obtained. Furthermore, in the production processing of the battery 30, it is possible to assuredly suppress the contamination of an electrolyte in the heat-sealed portion 23 of the packaging material 1. The particularly preferred lower limit of Sa is 0.1 μm.

Here, when the ratio E_{IT}/H_{IT} of the heat-fusible resin layer 4 is within the range of 21 to 50, the inner surface (i.e., the surface of the heat-fusible resin layer 4) 1a of the packaging material 1 becomes likely to be greater than 0.07 μm, i.e., Sa of the surface of the normal heat-fusible resin layer 4. Therefore, Sa can be easily set within the range of 0.07 μm to 0.3 μm when the ratio E_{IT}/H_{IT} is within the range of 21 to 50.

When the packaging material 1 is in the form of the coil 10, that is, when the packaging material coil 10 is produced by winding an elongated packaging material 1 into a coil shape, the preferred lower limit of Sa of the packaging material 1 of the coil outer peripheral portion 11 is 0.1 μm, and the particularly preferred lower limit of Sa is greater than 0.2 μm. The preferred lower limit of Sa of the packaging material 1 of the coil center portion 12 is 0.18 μm.

Note that the coil outer peripheral portion 11 means the portion from the outermost circumference of the coil to the second circumference that can be used as the packaging material product of the coil 10. The coil center portion 12 means the portion from the coil winding starting end to 200 m of the packaging material product of the coil 10.

By setting the ratio E_{IT}/H_{IT} within the range of 21 to 50, in the unloaded condition in which the packaging material 1 is unwound from the coil 10, the difference between Sa of the inner surface 1a of the packaging material 1 of the coil center portion 12 and Sa of the inner surface 1a of the packaging material 1 of the coil outer peripheral portion 11 can be assuredly suppressed be smaller than 0.07 μm. Therefore, variations in Sa within the same coil 10 are assuredly suppressed, and therefore, the quality stability at the time of molding the packaging material 1 can be assuredly obtained.

Further, by setting the ratio E_{IT}/H_{IT} within the range of 21 to 50, in the unloaded condition in which the packaging material 1 is unwound from the coil 10, the dynamic friction coefficient of the inner surface 1a of the packaging material 1 of the coil outer peripheral portion 11 and the dynamic friction coefficient of the inner surface 1a of the packaging material 1 of the coil center portion 12 can be assuredly set to 0.25 or less. Therefore, it is possible to assuredly obtain good molding workability over the substantially entire length region of the packaging material 1.

Although some embodiments of the present invention have been described above, the present invention is not limited to the above-described embodiments and can be variously modified without departing from the gist of the present invention.

For example, in the above-described embodiments, in the packaging material 1, the metal foil layer 3 and the heat-fusible resin layer 4 are bonded to each other via the inner side adhesive layer Ha. However, for example, both the layers 3 and 4 may be bonded to each other without using the inner side adhesive layer 8a in the present invention.

Further, in the present invention, the body of the power storage device packaged with the packaging material is not limited to a battery main body of a battery, such as, e.g., a lithium-ion secondary battery, and may be, for example, a capacitor body of various capacitors.

### EXAMPLES

Specific Examples and Comparative Examples of the present invention are shown below. However, it should be noted that the present invention is not limited to the examples described below.

TABLE 1

| | Heat-fusible resin film | | | | | | | | | | | |
|---|---|---|---|---|---|---|---|---|---|---|---|---|
| | | | Seal layer | | | | | | | | | |
| | | | | | | | | Roughening material | | | | |
| | | | | | AB material | | | | Average | | Lubricant | |
| | | | Resin | | | Average | Addition | | particle | Addition | | Addition |
| | | Thickness | | Thickness | | thickness | rate | | diameter | rate | | rate |
| | Type | (μm) | Type | (μm) | Type | (μm) | (ppm) | Type | (μm) | (ppm) | Type | (rpm) |
| Ex. 1 | Three | 80 | rPP | 12 | Silica | 3 | 3,000 | HDPE | 10 | 5,000 | Erucamide | 2,400 |
| | layers | | | | | | | beads | | | | |
| Ex. 2 | Three | 80 | rPP + | 12 | Silica | 1 | 1,000 | HDPE | 8 | 4,000 | Erucamide | 2,000 |
| | layers | | hPP | | | | | beads | | | | |
| Ex. 3 | Three | 80 | rPP + | 12 | Ca | 2 | 2,000 | HDPE | 8 | 3,000 | Erucamide | 1,800 |
| | layers | | hPP | | carbonate | | | beads | | | | |
| Ex. 4 | Three | 40 | rPP | 6 | Silica | 1 | 2,500 | HDPE | 6 | 1,500 | Erucamide | 1,200 |
| | layers | | | | | | | beads | | | | |
| Ex. 5 | Three | 80 | rPP | 12 | Silica | 3 | 3,000 | HDPE | 10 | 5,000 | Erucamide | 1,600 |
| | layers | | | | | | | beads | | | | |
| Ex. 6 | Three | 80 | hPP | 12 | Silica | 1 | 500 | Acrylic | 6 | 1,000 | Erucamide | 1,800 |
| | layers | | | | | | | resin | | | | |
| | | | | | | | | beads | | | | |
| Ex. 7 | Three | 40 | rPP + | 6 | Alumina | 4 | 3,500 | Acrylic | 6 | 5,000 | Erucamide | 600 |
| | layers | | hPP | | | | | resin | | | | |
| | | | | | | | | beads | | | | |
| Ex. 8 | Single | 30 | rPP | 30 | Silica | 4 | 3,000 | HDPE | 12 | 4,000 | Erucamide | 3,000 |
| | layer | | | | | | | beads | | | | |
| Comp. | Three | 80 | hPP | 12 | Silica | 1 | 500 | — | — | — | Erucamide | 1,600 |
| Ex. 1 | layers | | | | | | | | | | | |
| Comp. | Three | 80 | rPP | 12 | Ca | 2 | 1,000 | HDPE | 8 | 2,000 | Erucamide | 400 |
| Ex. 2 | layers | | | | carbonate | | | beads | | | | |
| Comp. | Three | 80 | rPP + | 12 | Silica | 4 | 3,000 | HDPE | 12 | 3,500 | Erucamide | 3,500 |
| Ex. 3 | layers | | hPP | | | | | beads | | | | |
| Comp. | Single | 30 | rPP | 30 | Silica | 3 | 3,000 | HDPE | 12 | 5,000 | Erucamide | 2,000 |
| Ex. 4 | layer | | | | | | | beads | | | | |

TABLE 2

| | Hear-fusible resin layer | | | | | | | | | | | | | |
|---|---|---|---|---|---|---|---|---|---|---|---|---|---|---|
| | Intermediate layer | | | | | Laminate layer | | | | | | | | |
| | | | AB | | | | | AB material | | | | | | Total |
| | | | material/ | | | | | | Ave. | | Roughing | | | lubri- |
| | Resin | | Roughing | Lubricant | | Resin | | | par- | | material | Lubricant | | cant |
| | | Thick- | material | | Addition | | Thick- | | ticle | Addition | Addition | | Addition | con- |
| | | ness | Addition | | rate | | ness | | diam- | rate | rate | | rate | tent |
| | Type | (μm) | rate | Type | (μm) | Type | (μm) | Type | eter | (ppm) | (ppm) | Type | (ppm) | (ppm) |
| Ex. 1 | bPP | 56 | No | Eruc- | 4,800 | rPP | 12 | Silica | 1 | 1,000 | No | Eruc- | 800 | 3,840 |
| | | | additives | amide | | | | | | | additives | amide | | |
| Ex. 2 | bPP | 56 | No | Eruc- | 5,400 | hPP | 12 | Ca car- | 2 | 2,000 | No | Eruc- | 800 | 4,200 |
| | | | additives | amide | | | | bonate | | | additives | amide | | |
| Ex. 3 | bPP | 56 | No | Eruc- | 4,800 | rPP + | 12 | — | — | — | No | Eruc- | 1,600 | 3,870 |
| | | | additives | amide | | hPP | | | | | additives | amide | | |
| Ex. 4 | bPP | 28 | No | Eruc- | 5,400 | hPP | 6 | Ca car- | 2 | 2,000 | No | Eruc- | 800 | 4,080 |
| | | | additives | amide | | | | bonate | | | additives | amide | | |
| Ex. 5 | bPP | 56 | No | Eruc- | 4,800 | rPP + | 12 | — | — | — | No | Eruc- | 1,600 | 3,840 |
| | | | additives | amide | | hPP | | | | | additives | amide | | |
| Ex. 6 | bPP | 56 | No | Eruc- | 4,800 | rPP | 12 | Silica | 1 | 1,000 | No | Eruc- | 800 | 3,750 |
| | | | additives | amide | | | | | | | additives | amide | | |
| Ex. 7 | bPP | 28 | No | Eruc- | 4,800 | rPP + | 6 | — | — | — | No | Eruc- | 1,600 | 3,690 |
| | | | additives | amide | | hPP | | | | | additives | amide | | |
| Ex. 8 | — | — | — | — | — | — | — | — | — | — | — | — | — | 3,000 |
| Comp. | bPP | 56 | No | Eruc- | 4,800 | rPP | 12 | Silica | 1 | 1,000 | No | Eruc- | 800 | 3,720 |
| Ex. 1 | | | additives | amide | | | | | | | additives | amide | | |
| Comp. | bPP | 56 | No | Eruc- | 5,400 | hPP | 12 | Ca car- | 2 | 2,000 | No | Eruc- | 800 | 3,960 |
| Ex. 2 | | | additives | amide | | | | bonate | | | additives | amide | | |
| Comp. | bPP | 56 | No | Eruc- | 4,800 | rPP + | 12 | — | — | — | No | Eruc- | 1,600 | 4,125 |
| Ex. 3 | | | additives | amide | | hPP | | | | | additives | amide | | |
| Comp. | — | — | — | — | — | — | — | — | — | — | — | — | — | 2,000 |
| Ex. 4 | | | | | | | | | | | | | | |

TABLE 3

| | | | | | Coil | | | | | |
|---|---|---|---|---|---|---|---|---|---|---|
| | | | | | center | Dynamic friction | | | | |
| | Coil outer peripheral portion | | | | portion | coefficient | | Molding workability | | |
| | | | Shape | Arithmetic | Arithmetic | Coil | | Coil | | |
| | Indentation | Indentation | recovery | mean height | mean height | outer | Coil | outer | Coil | |
| | hardness H_{IT} | modulus E_{IT} | rate | Sa | Sa | peripheral | center | peripheral | center | Total |
| | (N/mm²) | (N/mm²) | E_{IT}/H_{IT} | (μm) | (μm) | portion | portion | portion | portion | evaluation |
| Ex. 1 | 21.40 | 979.0 | 45.75 | 0.29 | 0.27 | 0.03 | 0.03 | ⊚ | ⊚ | ⊚ |
| Ex. 2 | 30.98 | 758.5 | 24.48 | 0.23 | 0.22 | 0.04 | 0.03 | ⊚ | ⊚ | ⊚ |
| Ex. 3 | 25.69 | 785.1 | 30.56 | 0.22 | 0.18 | 0.05 | 0.06 | ⊚ | ⊚ | ⊚ |
| Ex. 4 | 25.12 | 582.2 | 23.18 | 0.14 | 0.12 | 0.13 | 0.17 | ◯ | ◯ | ⊚ |
| Ex. 5 | 27.68 | 605.8 | 21.89 | 0.27 | 0.23 | 0.02 | 0.04 | ⊚ | ⊚ | ⊚ |
| Ex. 6 | 28.29 | 624.2 | 22.06 | 0.08 | 0.08 | 0.18 | 0.20 | ◯ | ◯ | ◯ |
| Ex. 7 | 26.21 | 559.6 | 21.35 | 0.21 | 0.14 | 0.10 | 0.17 | ⊚ | ◯ | ◯ |
| Ex. 8 | 28.58 | 609.0 | 21.31 | 0.19 | 0.14 | 0.10 | 0.16 | ⊚ | ◯ | ◯ |
| Comp. | 29.98 | 588.8 | 19.64 | 0.05 | 0.01 | 0.29 | 0.36 | ◯ | X | X |
| Ex. 1 | | | | | | | | | | |
| Comp. | 28.16 | 570.8 | 20.27 | 0.20 | 0.08 | 0.19 | 0.28 | ◯ | X | X |
| Ex. 2 | | | | | | | | | | |
| Comp. | 19.10 | 983.1 | 51.47 | 0.19 | 0.16 | 0.16 | 0.26 | ◯ | X | X |
| Ex. 3 | | | | | | | | | | |
| Comp. | 25.41 | 377.0 | 14.84 | 0.15 | 0.04 | 0.19 | 0.31 | ◯ | X | X |
| Ex. 4 | | | | | | | | | | |

### 1. Production of Polyolefin-Based Film

As a polyolefin-based film (hereinafter also referred to as “heat-fusible resin film”) constituting the heat-fusible resin layer 4 of the packaging material 1, a single-layer CPP film and a three-layer coextruded CPP film were produced by the following method.

### (1) Single-Layer CPP Film

Single-layer CPP films having different surface properties and a thickness of 30 μm were produced by adding a predetermined amount of an AB material, a roughening material, and a lubricant to rPP and adjusting the film formation condition (Example 8, Comparative Example 4). Silica fineparticles were used as the AB material, an HDPE (high-density-polyethylene) beads were used as the roughening material, and erucamide was used as the lubricant. The details are shown in Tables 1 and 2.

In Tables 1 and 2, the addition rate of the AB material, the addition rate of the roughening material, and the addition rate of the lubricant all mean the mass addition rate. The same applies hereinafter.

### (2) Three-Layer Coextrusion CPP Film

Three-layer co-extruded CPP films were produced. The films had a thickness of 40 μm and a thickness of 80 μm and different in the surface property and included an intermediate layer 6 of bPP, a seal layer 7 and a laminate layer 5 of rPP and/or hPP, The films were produced by adding a predetermined amount of a roughening material and/or a lubricant and adjusting the film formation condition (Examples 1 to 7, Comparative Examples 1 to 3). As the AB material, silica fine particles, calcium carbonate (Ca carbonate) fine particles or alumina fine particles were used. As the roughening material, HDPE beads or acrylic resin beads were used. As the lubricant, erucamide was used. The details are shown in Tables 1 and 2.

### 2. Production of Packaging Material

A chemical conversion treatment film (thickness: 0.01 μm) was formed as an underlying layer 3a on both the inner and outer surfaces of an aluminum foil (metal foil layer 3) (material: A8021-0) having a thickness of 40 μm, a width of 500 mm, and a length of 2,000 m of an aluminum foil coil. The formation of this chemical conversion treatment film was performed by applying a chemical conversion treatment solution consisting of phosphoric acid, polyacrylic acid (acryl-based resin), a chromium (III) salt compound, water, and alcohol to both surfaces of the aluminum foil, followed by drying at 180° C. The chromium adhesion amount of the chemical conversion treatment coating was 5 mg/m² per one side of the aluminum foil.

Then, a biaxially stretched 6-nylon (ONy) film having a thickness of 25 μm as the substrate layer 2 was dry-laminated on one surface (outer surface) of the above-described chemical conversion treated aluminum foil via a two-part curing type urethane-based adhesive agent layer (thickness: 3 μm) as the outer side adhesive layer 8b.

Next, on the outer surface of the above-described single-layer CPP film or on the outer surface of the laminate layer 5 of the above-described three-layer coextruded CPP film, the other surface (inner surface) of the inner side adhesive layer 8a was overlapped via a two-part curing type adhesive layer (thickness: 2 μm) as the inner side adhesive layer 8a. And they are sandwiched between a rubber nip roll and a laminate roll heated to 100° C. and then dry-laminated, followed by aging at 40° C. for 7 days to produce a packaging material coil 10 having a length 2,000 m.

Note that the outer surface of the above-described single-layer CPP film and the outer surface of the laminate layer 5 of the above-described three-layer coextruded film were subjected to a corona treatment before the other surface (inner surface) of the above-described dry-laminated aluminum foil was overlapped on the outer surface. Further, as the two-part curing type adhesive as the inner side adhesive layer 8a, a two-part curing type adhesive of maleic acid-modified polypropylene and isocyanate was used.

### 3. Evaluation

In the above-described packaging material coil 10, a plurality of evaluation packaging materials was taken out from a portion of the second circumference from the coil outermost circumference as the packaging material 1 of the coil outer peripheral portion 11, and a plurality of evaluation packaging materials was taken out from a portion of the coil center portion 12 separated from the dry lamination starting portion by about 100 m as the packaging material 1 of the coil center portion 12. Note that the dry lamination starting portion substantially coincides with the winding starting end portion of the packaging material 1 on the core member 15. That is, in the above-described packaging material coil 10, the sampling position of the evaluation packaging material of the coil outer peripheral portion 11 is a portion of about the second circumference from the outermost circumference of the coil. In the above-mentioned packaging material coil 10, the sampling position of the packaging material for evaluation in the coil center portion 12 of the coil was about 100 m away from the coil starting end portion.

Then, for the collected packaging materials for evaluation, the indentation modulus E_{IT}, the indentation hardness H_{IT}, the arithmetic mean height Sa, and the coefficient of dynamic friction of the heat-fusible resin layer 4 were measured, and the molding workability test was conducted. The results are shown in Table 3.

The methods for measuring E_{IT}, H_{IT}, Sa, and the dynamic friction coefficient, and the test method of the molding workability were as follows.

<Indentation Modulus E_{IT} and Indentation Hardness H_{IT}>

One drop of an instantaneous adhesive “Aron Alpha (registered trademark)” manufactured by Toagosei Co., Ltd. was applied onto a slide glass, and the outer 1b of the sample piece taken from the evaluation packaging material, i.e., the surface of the substrate layer 2, was bonded to the slide glass via the instantaneous adhesive. Then, the inner surface 1a of the sample piece, i.e., the surface of the heat-fusible resin layer 4 (seal layer 7), was used as the measuring surface, and E_{IT} and H_{IT} were measured using a Berkovich indenter according to IS014577 (instrumented indentation test). The measurement was performed at least five times, and the arithmetic mean of the measurements was taken as E_{IT} and H_{IT} values. The ratio E_{IT}/H_{IT} of E_{IT} to H_{IT} was calculated as the shape recoverability of the heat-fusible resin layer 4.

The device used for this measurement was a dynamic microhardness meter (model number: DUH-211) manufactured by Shimadzu Corporation, and the measurement conditions are as follows.
Berkovich indenter: apex angle 115.0° triangular pyramid diamond indenter
Temperature: 23° C.
Measured relative humidity: 60% RH
Indentation load speed: 2.6648 mN/s
Maximum indentation depth: 10% of the thickness of the heat-fusible resin layer 4 (e.g. 80 μm thick heat-fusible resin film with a maximum indentation depth of 8 μm)
Maximum Load retention time:5 s.

### <Arithmetic Mean Height Sa>

The arithmetic mean height Sa was measured as the surface roughness for the inner surface 1a of the specimen taken from the packaging material, i.e., the surface of the heat-fusible resin layer 4 (seal layer 7).

The device used for this measurement was a scanning white light interferometer (model number: VS1330) manufactured by Hitachi High-Tech Co., Ltd., and its surface space resolution is 350 nm, and its vertical-direction resolution is 0.01 nm.

Using this device, Sa was measured by a white light interference microscopy (vertical scanning low coherence interferometry) according to IS025178 for a square-shaped measurement target region of 1,000 μm in length×1,000 μm in width in the inner surface 1a of the sample piece. This measurement was performed at least three times, and the arithmetic mean of the measurement was taken as the value of Sa.

<Dynamic Friction Coefficient>

For the inner surface 1a of the sample piece taken from the evaluation packaging material, that is, the surface of the heat-fusible resin layer 4 (seal layer 7), the dynamic friction coefficient was measured according to JIS K7125 using a friction measuring instrument TR manufactured by Toyo Seiki Seisakusho, Ltd. This measurement was performed at least three times, and the arithmetic mean value of the measured value was taken as the value of the dynamic friction coefficient.

### <Holding Workability>

Using a press forming machine manufactured by Amada Co., Ltd. (part number: TP-25C-X2), the evaluation packaging material was deep drawn into a rectangular parallelepiped container shape having a vertical 55 mm×horizontal 35 mm×depth 4 mm to 8 mm at a molding processing speed of 20 spm. The molding workability of the packaging material was evaluated by visually checking the presence or absence of pinholes at the corner portion of the obtained deep-drawn molded article by transmitting light, and examining the maximal molding processing depth at which pinholes did not occur. The evaluation criteria are as follows. Note that the marks “⊚” and “◯” indicate that the sample passed the molding workability test.
⊚: Maximum molding processing depth was equal to or more than 7 mm
◯: Maximum molding processing depth was equal to or more than 5 mm and less than 7 mm
X: Maximum molding processing depth was less than 5 mm.

Then, based on the difference (this difference is hereinafter referred to as “difference of maximum molding processing depth”) between the maximum molding processing depth of the packaging material 1 of the coil outer peripheral portion 11 and the maximum molding processing depth of the packaging material 1 of the coil center portion 12, the molding workability was comprehensively evaluated. The symbols in the “Overall Evaluation” in the column of Table 3 mean as follows. Note that “@” and “0” are regarded as passing the overall evaluation of the molding workability test.
⊚: Maximum molding processing depth difference was 0.5 mm or less
◯: Maximum molding processing depth difference exceeded 0.5 mm and 1 mm or less
X: Maximum molding processing depth difference was greater than 1 mm.

As can be understood from the “Overall Evaluation” column in Table 3, for Examples 1 to 8, the difference between the maximum molding processing depth of the packaging material 1 of the coil outer peripheral portion 11 and the maximum molding processing depth of the packaging material 1 of the coil center portion 12 was small. Therefore, when the ratio E_{IT}/H_{IT} is within the range of 21 to 50, it is considered that the packaging material 1 has less variation in the length region from the coil outer peripheral portion 11 to the coil center portion 12, that is, the molding workability over the substantially entire length region of the packaging material 1. Therefore, stable molding workability can be obtained over the substantially entire length region of the packaging material 1.

Furthermore, in the case where Sa is 0.07 μm to 0.3 μm (see the column of “arithmetic average height Sa” in Table 3) and in the case where the mass content of the lubricant in the seal layer 7 of the heat-fusible resin layer (heat-fusible resin film) 4 is within the range of 500 ppm to 3,000 ppm (refer to the column of “addition rate” in the column of “lubricant” in Table 1), it was possible to assuredly obtain good molding workability.

This application claims priority to Japanese Patent Application No. 2022-70091 filed on Apr. 21, 2022, and Japanese Patent Application No. 2023-46343 filed on Mar. 23, 2023, the disclosure of which is incorporated herein by reference in its entirety.

The terms and expressions used herein are for illustration purposes only and are not used for limited interpretation, do not exclude any equivalents of the features shown and stated herein, and it should be recognized that the present invention allows various modifications within the scope of the present invention as claimed.

### INDUSTRIAL APPLICABILITY

The present invention can be used for a packaging material for a power storage device, such as, e.g., a battery (e.g., a lithium-ion secondary battery, an all-solid-state battery), a capacitor (e.g., an electric double layer capacitor, a lithium-ion capacitor), etc.

### DESCRIPTION OF SYMBOLS

1: Packaging material
1a: Inner surface of a packaging material
2: Substrate layer
3: Metal foil layer
4: Heat-fusible resin layer
20: Packaging case
21: Packaging case body (molded article)
30: Battery (power storage device)
31: Battery main body (power storage device main body)

1. A packaging material for a power storage device, comprising:
a laminated material in which a metal foil layer, a substrate layer provided on an outer surface side of the metal foil layer, and a heat-fusible resin layer provided on an inner surface side of the metal foil layer are laminated,
wherein the heat-fusible resin layer is arranged on an inner surface of the packaging material,
wherein the heat-fusible resin layer is formed of a polyolefin-based film, and
wherein a ratio E_{IT}/H_{IT} of an indentation modulus E_{IT} to an indentation hardness H_{IT} of the heat-fusible resin layer measured using a Berkovich indenter is within a range of 21 to 50.

2. The packaging material for a power storage device as recited in claim 1,
wherein an arithmetic mean height Sa of the inner surface of the packaging material is within a range of 0.07 μm and 0.3 μm.

3. The packaging material for a power storage device as recited in claim 1,
wherein the polyolefin-based film is formed of at least one-layer film,
wherein at least in the one-layer film, a film forming the inner surface of the packaging material contains 500 ppm to 3,000 ppm by mass content of a fatty acid amide-based lubricant.

4. A packaging case for a power storage device provided with a deep-drawn molded article or a stretch-molded article of the packaging material as recited in claim 1.

5. A power storage device in which a power storage device main body is accommodated in a packaging case provided with a deep-drawn molded article or a stretch-molded article of the packaging material as recited in claim 1.
